(19) United States
(12) Patent Application Publication
(10) Pub. No.: US 2024/0334340 A1
(43) Pub. Date: Oct. 3, 2024

(54) DYNAMIC ADJUSTMENT OF MEMORY OPERATING FREQUENCY TO AVOID RF INTERFERENCE WITH WIFI

(71) Applicants: Advanced Micro Devices, Inc., Santa Clara, CA (US); ATI Technologies ULC, Markham (CA)

(72) Inventors: Paul Blinzer, Bellevue, WA (US); Chirag Nitinkumar Dhruv, Austin, TX (US); Ranjeet Kumar, Markham (CA); Gia Tung Phan, Markham (CA); Ashish Jain, Austin, TX (US)

(21) Appl. No.: 18/128,805

(22) Filed: Mar. 30, 2023

(51) Int. Cl. H04W 52/02

(52) U.S. Cl. CPC H04W 52/029; H04W 52/0274

(57) ABSTRACT

An apparatus and method for efficiently performing power management for increasing reliable wireless signal transfer performed by mobile computing devices. In various implementations, a computing system includes a network interface and multiple components for processing tasks. The network interface sends, to at least a given component of the multiple components, an indication specifying the corresponding operating frequency ranges used by one or more radio modules used for wireless communication with an access point. The given component determines whether an operating clock frequency of the given component overlaps any of the received operating frequency ranges and associated harmonic frequencies. If so, then the given component changes the operating clock frequency to a frequency that does not overlap any of the received operating frequency ranges and associated harmonic frequencies.

### BACKGROUND

### Description of the Relevant Art

Computing networks are widely used for communication between computing devices in businesses and homes across the globe. For example, local businesses, factories, schools, hospitals and other healthcare sites, financial institutions, and other corporations use wireless networks. Examples of the computing devices are laptop computers, tablet computers, smartphones, smartwatches, and so forth. In many cases, the network is based on (or otherwise incorporates the use of) radio signal transmissions rather than wired connections. For example, Wi-Fi networks and Bluetooth networks are examples of wireless networks. A wireless local area network (WLAN) supports wireless connections of multiple endpoints such as the variety of types of computing devices within the network and a variety of peripheral devices within the network. The WLAN transfers data as packets from a base station, such as a wireless router, to one or more endpoints. To further extend the area of access of the wireless network, one or more access points are added to the wireless network to allow devices that aren't near the base station to access the network. The access points include another wireless router or wireless transmitter.

While wireless networks enable efficient deployment compared to wired networks, they have potential issues related to wireless communication that must be considered. For example, wireless signal interference that occurs when using wireless networks can reduce the reliability of the wireless data transfer. Further, as the operating clock frequencies of computing components increases, the likelihood of interference between such components and wireless networks increases. For example, clock signals and other signals transferred on printed circuit boards can interfere with the wireless radio-based signals transferred between an access point and a mobile computing device. In addition, as the lengths of signals wires of the different subsystems of the computing device increase, the chance of interference increases.

Signal interference between signals within semiconductor chips and between signals on printed circuit boards can result from capacitive coupling (electric field dominant coupling), inductive coupling (magnetic field dominant coupling), and electromagnetic field coupling. While reducing the operating clock frequencies would reduce the signal interference, this would also reduce performance which may be undesirable. Physical solutions used to reduce signal interference include shielding the signals that use a power supply reference signal and/or a ground reference signal, and increasing the distance between interfering signals. However, the area on the printed circuit boards of computing devices (especially smaller mobile computing devices) is limited, which hinders use of these solutions.

In view of the above, efficient methods and systems that increase reliable wireless signal transfer of mobile computing devices are desired.

### BRIEF DESCRIPTION OF THE DRAWINGS

FIG. 1 is a generalized block diagram of a computing system that increases reliable wireless signal transfer of computing devices.

FIG. 2 is a generalized block diagram of a method for increasing reliable wireless signal transfer performed by a computing device.

FIG. 3 is a generalized block diagram of a computing system that increases reliable wireless signal transfer of computing devices.

FIG. 4 is a generalized block diagram of a clock frequency modifying circuit.

FIG. 5 is a generalized block diagram of a method for increasing reliable wireless signal transfer performed by a computing device.

FIG. 6 is a generalized block diagram of a method for increasing reliable wireless signal transfer performed by a computing device.

FIG. 7 is a generalized block diagram of a method for increasing reliable wireless signal transfer performed by a computing device.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

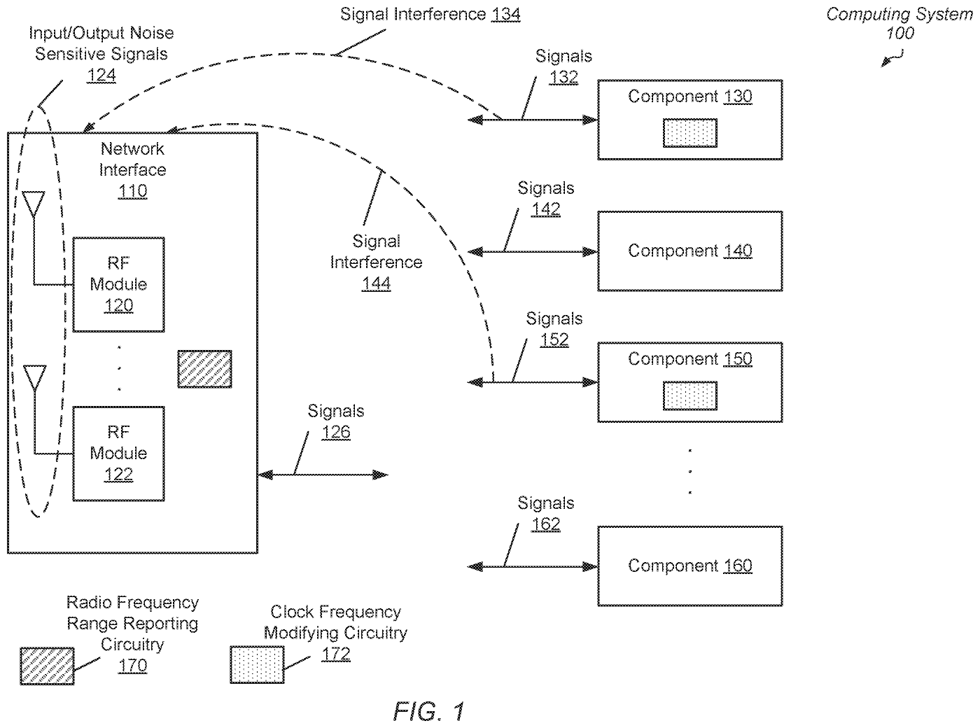

Apparatuses and methods for increasing reliable wireless signal transfer performed by a computing device are contemplated. In various implementations, a computing system includes a network interface and multiple components for processing tasks. In some implementations, the multiple components are subsystems on a printed circuit board of a mobile computing device. Examples of the components are a system on a chip (SoC), phased locked loop circuitry that provides system clock signals, one of a variety of types of off-chip system memory, a display engine, and so forth. Circuitry of the network interface sends, to at least a given component of the multiple components, an indication specifying the corresponding operating frequency ranges used by one or more radio modules for wireless communication. The hardware (e.g., circuitry) of the given component determines whether an operating clock frequency of the given component overlaps any of the received operating frequency ranges and associated harmonic frequencies. If so, then the given component changes the operating clock frequency to a frequency that does not overlap any of the received operating frequency ranges and associated harmonic frequencies. Further details are provided in the following discussion of FIGS. 1-7.

Turning now to FIG. 1, a generalized block diagram is shown of a computing system 100 that increases reliable wireless signal transfer of computing devices. As shown, the computing system 100 includes at least the network interface 110 and the components 130, 140, 150 and 160. In some implementations, the computing system 100 is a printed circuit board of a mobile computing device and the components 130-160 are subsystems on the printed circuit board. The signals 126, 132, 142, 152, and 162 represent metal traces on the printed circuit board that transfer payload data, control signals, messages, and other types of information between a corresponding component of the components 130-160 and other areas of the computing system 100. One or more of these traces can effectively act as an antenna during operation and cause interference with other radio frequency signals. For example, as shown, at least the signals 132 and 152 are capable of generating signal interference 134 and 144 on the input/output noise sensitive signals 124 of the network interface 110. The circuitry 170 and 172 are used to reduce or remove the signal interference 134 and 144.

The hardware, such as circuitry, of the components 130-160 provide a variety of functionalities. Examples of the components 130-160, which are subsystems on the printed circuit board, are a system on a chip (SoC), phased locked loop circuitry that provides system clock signals, one of a variety of types of system memory (on or off chip), a display engine, and so forth. Although the placement of the components 130-160 are shown in a particular location and order, in various implementations, the location and order vary based on the floor planning of the printed circuit board. In addition, the number of the components 130-160 is based on design requirements.

The network interface 110 includes hardware, such as circuitry, for supporting one or more wireless communication protocols and processing one or more types of received requests. In various implementations, the network interface 110 supports one of multiple versions of the Institute of Electrical and Electronics Engineers (IEEE) 802.11 Wireless LAN protocol standard. In one implementation, the network interface 110 supports one of the IEEE 802.11ax Wireless LAN protocol standard, which includes the Wi-Fi 6 protocol and the Wi-Fi 6E protocol. In another implementation, the network interface 110 supports the IEEE 802.11be Wireless LAN protocol standard, which is also referred to as the Wi-Fi 7 protocol. Although not shown, in other implementations, the network interface 110 also supports the Bluetooth protocol standard for wirelessly transferring packets with another computing device.

The Wireless LAN protocol (WLAN) supports a wireless information distribution between an access point, such as a wireless router, and an endpoint such as one of a variety of computing devices that uses at least the circuitry of the computing system 100. Examples of the computing devices are desktop computers and mobile computing devices such as laptops, tablet computers, smartphones, smartwatches, netbook computers, and so forth. The radio frequency (RF) modules 120-122 of the network interface 110 wirelessly transfer packets with an external access point (not shown) such as a wireless router. The circuitry of the RF modules 120-122 (or radio modules 120-122) include an antenna, data conversion circuitry, and other data processing circuitry. In some implementations, the network interface 110 also includes a microcontroller or processing unit that is capable of processing one or more types of received packets. Therefore, some packets are not transmitted from the network interface 110 to one of the components 130-160 such as a system on a chip (SoC).

The IEEE 802.11 Wireless LAN protocol standard provides multiple distinct radio frequency bands for use in wireless communications. The standard includes the 900 megahertz (MHz) band, the 2.4 gigahertz (GHz) band, the 3.6 GHz band, the 4.9 GHz band, the 5 GHz band, the 5.9 GHz band, the 6 GHz band, and the 60 GHz band. Each of these bands includes multiple channels with each channel having a respective frequency range. For example, the 2.4 GHz band includes 14 channels. A first channel of the fourteen channels includes the frequency range 2.401 GHz to 2.423 GHz. A second channel of the fourteen channels includes the frequency range 2.406 GHz to 2.428 GHz, and so on. In an implementation, each of the RF modules 120-122 supports one of the available frequency bands of the wireless communication protocol standard.

Each of the signals 126, 132, 142, 152, and 162 include corresponding data payload buses, address buses, and control signals. The metal traces on the printed circuit board used to transfer the signals 126, 132, 142, 152, and 162 have corresponding parameters such as metal widths, metal thicknesses, trace lengths, particular metal compositions, signal routing shapes, operating frequencies, bus widths, and so on. These parameters affect whether the signals 126, 132, 142, 152, and 162 generate signal interference with another set of signals. For example, in the illustrated implementation, at least the signals 132 and 152 are capable of generating signal interference 134 and 144 on the input/output noise sensitive signals 124 of the network interface 110. The signal interference 134 and 144 between the sensitive signals 124 and the signals 132 and 152 result from capacitive coupling (electric field dominant coupling), inductive coupling (magnetic field dominant coupling), and electromagnetic field coupling.

To reduce or remove the signal interference 134 and 144 between the sensitive signals 124 and the signals 132 and 152, the network interface 110 includes the radio frequency range reporting circuitry 170 (or circuitry 170) that sends the one or more frequency ranges currently being used by the network interface 110 to one or more of the components 130-160. In some implementations, the circuitry 170 uses the Advanced Configuration and Power Interface (ACPI) specification for communicating the frequency ranges information to one or more of the components 130-160. In an implementation, firmware executed by a processor or other circuitry within the network interface 110 generates a general-purpose input/output (GPIO) interrupt that is sent to an interrupt controller (not shown) in the computing system 100. The interrupt controller sends an indication to one or more of the components 130-160. In an implementation, the indication specifies the one or more frequency ranges currently being used by the network interface 110. In another implementation, the indication specifies a memory location to inspect to determine the one or more frequency ranges currently being used by the network interface 110. In such an implementation, the operating system and one or more of the components 130-160 need not periodically check what frequency ranges are currently being used by the network interface 110.

In an implementation, the components 130 and 150 receive information specifying the one or more frequency ranges currently being used by the network interface 110. In some implementations, a frequency range of the one or more frequency ranges correspond to a distinct radio frequency band. In another implementation, a frequency range of the one or more frequency ranges correspond to a particular channel of a distinct radio frequency band. The components 130 and 150 include the clock frequency modifying circuitry 172 (or circuitry 172) that adjusts an operating clock frequency based on the received information. The circuitry 172 of the component 130 determines whether an operating clock frequency used by the component 130 overlaps with any of the one or more frequency ranges currently being used by the network interface 110. If so, the circuitry 172 adjusts the operating clock frequency to a frequency value that does not overlap with any of the one or more frequency ranges currently being used by the network interface 110. In some implementations, the circuitry 172 maintains thresholds for frequency ranges. The circuitry 172 ensures an absolute value of a difference between an adjusted operating clock frequency and a lower or upper frequency limit of the frequency range is greater than the corresponding threshold.

In an example, the RF module 120 (or radio module 120) currently uses channel 9 of the 2.4 GHz band, which has a frequency range of 2.441 GHz to 2.463 GHz. Circuitry of the component 130 currently uses an operating clock frequency of 2.45 GHz, which overlaps this frequency range of the RF module 120. When using a threshold of 0.03 GHZ, the circuitry 172 of the component 130 adjusts the operating clock frequency from 2.45 GHz to 2.40 GHz (as an example). The difference between the lower limit of the frequency range (2.441 GHz) and the adjusted operating clock frequency (2.40 GHz) is (2.441 GHz−2.40 GHZ=0.041 GHz, which is greater than the threshold of 0.03 GHz. Therefore, circuitry of the component 130 begins to use an operating clock frequency of 2.40 GHz. The circuitry 172 of the component 150 performs similar steps.

In various implementations, the circuitry 172 also determines corresponding harmonic frequencies for the one or more frequency ranges currently being used by the network interface 110. To determine a range that corresponds to the harmonic frequencies, the circuitry 172 multiplies the lower and upper frequency limits of a frequency range by a positive, non-zero integer. The circuitry 172 of the component 130 determines whether an operating clock frequency used by the component 130 overlaps with any of the determined one or more harmonic frequencies. If so, the circuitry 172 adjusts the operating clock frequency of the component 130 to a frequency value that does not overlap with any of the one or more frequency ranges currently being used by the network interface 110 or any harmonic frequencies corresponding to these one or more frequency ranges currently being used by the network interface 110. In some implementations, the circuitry 172 maintains overlap thresholds for frequency ranges.

In an example, the RF module 120 currently uses channel 7 of the 2.4 GHz band, which has a frequency range of 2.431 GHz to 2.453 GHZ. Circuitry of the component 130 currently uses an operating clock frequency of 4.90 GHz, which overlaps the second order harmonic frequency of this frequency range of the RF module 120. The circuitry 172 generates the second order harmonic frequency by multiplying the frequency range of the RF module 120 by the integer 2. The second order harmonic range is ((2×2.431 GHz) to (2×2.453 GHZ)), or 4.862 GHz to 4.906 GHz. When using an overlap threshold of 0.03 GHz, the circuitry 172 of the component 130 adjusts the operating clock frequency from 4.90 GHz to 4.95 GHz. The difference between the adjusted operating clock frequency (4.95 GHZ) and the upper limit of the frequency range (4.906 GHz) is (4.95 GHz−4.906 GHZ=0.044 GHz, which is greater than the overlap threshold of 0.03 GHz. Therefore, circuitry of the component 130 begins to use an operating clock frequency of 4.95 GHz. The circuitry 172 of the component 150 performs similar steps.

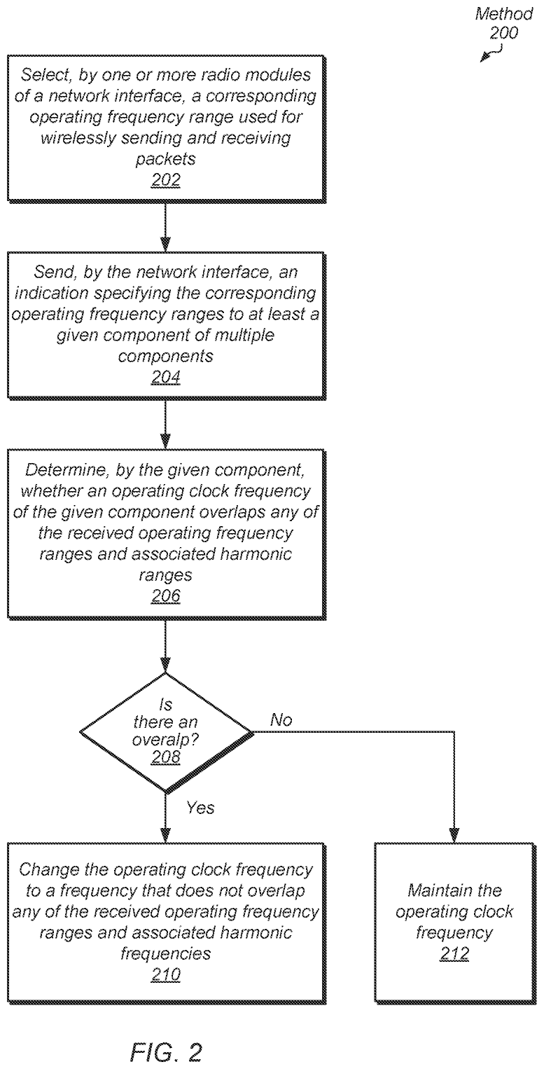

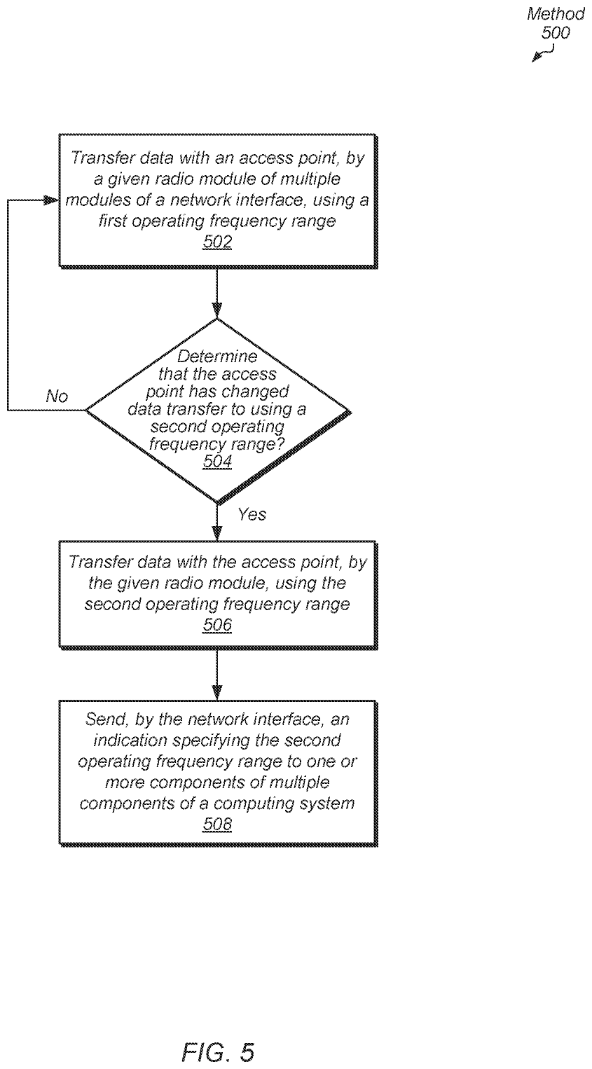

Turning now to FIG. 2, a generalized block diagram is shown of a method 200 for increasing reliable wireless signal transfer performed by a computing device. For purposes of discussion, the steps in this implementation (as well as in FIGS. 5-7) are shown in sequential order. However, in other implementations some steps occur in a different order than shown, some steps are performed concurrently, some steps are combined with other steps, and some steps are absent.

In various implementations, a computing system is a printed circuit board of a mobile computing device that includes multiple components for processing tasks. Examples of the components, which are subsystems on the printed circuit board, are a system on a chip (SoC), phased locked loop circuitry that provides system clock signals, memory clock signals, a display engine, and so forth. The computing system includes a network interface that is a network interface card in a slot on the motherboard of the remote computing device. In other implementations, the network interface is a local area network on motherboard (LOM) with circuitry in a semiconductor chip directly embedded on the motherboard. In an implementation, the network interface is a wireless local area network (WLAN) that supports a wireless connection with the network. One or more radio modules of the network interface select a corresponding operating frequency range used for sending and receiving packets to and from an access point (block 202).

Circuitry of a network interface sends (or otherwise makes available), to at least a given component of multiple components, an indication specifying the corresponding operating frequency ranges used by one or more radio modules (block 204). The hardware, such as circuitry, of the given component determines whether an operating clock frequency of the given component overlaps any of the received operating frequency ranges and associated harmonic frequencies (block 206). If there is an overlap (“yes” branch of the conditional block 208), then the given component changes the operating clock frequency to a frequency that does not overlap any of the received operating frequency ranges and associated harmonic frequencies (block 210). Otherwise, if there is not an overlap (“no” branch of the conditional block 208), then the given component maintains the operating clock frequency (block 212).

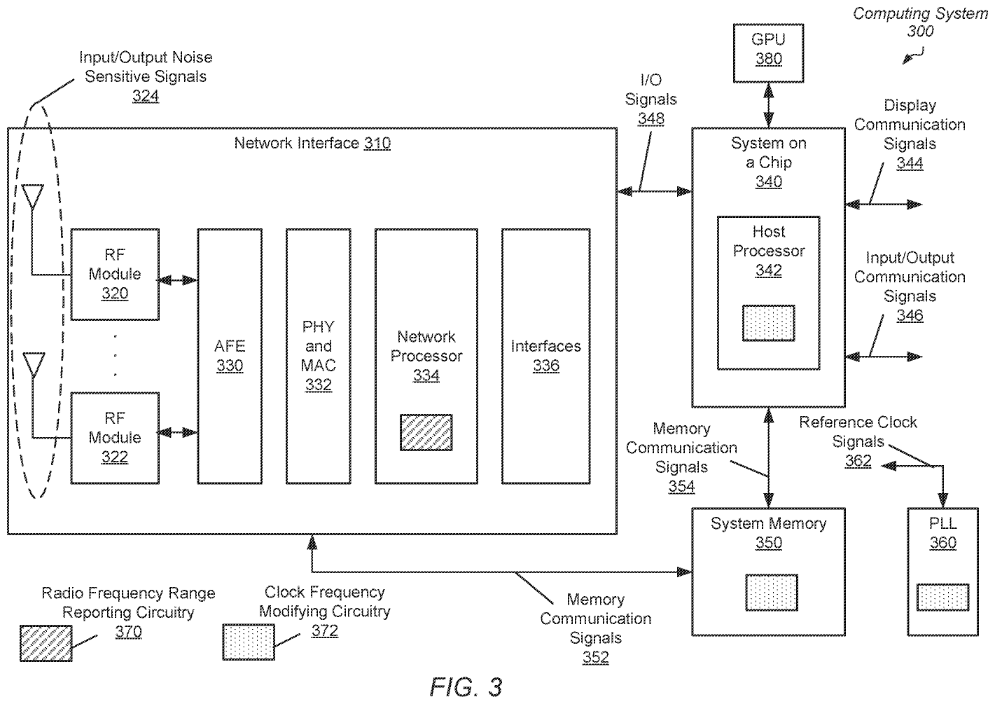

Referring to FIG. 3, a generalized block diagram is shown of a computing system 300 that increases the reliability of wireless signal communication. As shown, the computing system 300 includes at least the network interface 310 and the components 340, 350 and 360. In the illustrated implementation, the components 340-360 include the system on a chip (SoC) 340, graphics processing unit (GPU) 380, system memory 350, and the phased lock loop (PLL) 360. Other examples of components and another number of components are included in the computing system 300 in other implementations. In various implementations, the computing system 300 is a printed circuit board of a mobile computing device and the components 340-360 are subsystems on the printed circuit board. In some implementations, network interface 310 is part of the SoC 340.

The signals 344-348, 352-354, and 362 represent metal traces on the printed circuit board that transfer payload data, control signals, messages, and other types of information between a corresponding component of the components 340-360 and other areas of the computing system 300. In some implementations, at least the signals 344-348, 352-354, and 362 are capable of generating signal interference on the input/output noise sensitive signals 324 of the network interface 310. The circuitry 370 and 372 are used to reduce or remove this signal interference. In various implementations, the circuitry 370 and 372 have the same functionality as the circuitry 170 and 172 (of FIG. 1).

The network interface 310 includes hardware, such as circuitry, for supporting one or more wireless communication protocols and processing one or more types of received requests. In various implementations, the network interface 310 has the same functionality as the network interface 110 (of FIG. 1). For example, the network interface 310 supports one of multiple versions of the IEEE 802.11 Wireless LAN protocol standard. In an implementation, the network interface 310 also supports the Bluetooth protocol standard for wirelessly transferring packets with another computing device.

The radio frequency (RF) modules 320-322 wirelessly transfer packets with an external access point (not shown) such as a wireless router. The circuitry of the RF modules 320-322 include an antenna, data conversion circuitry, and other data processing circuitry. In various implementations, the RF modules 320-322 have the same functionality as the RF modules 120-122 (of FIG. 1). The circuitry of the network interface 310 includes an Analog Front End (AFE) 330 that includes switching circuitry, digital-to-analog converters (DACs), analog-to-digital converters (ADCs), a transmitter, a receiver, selection circuitry such as multiplexers, and clock generating circuitry. In some implementations, the functionality of the AFE 330 is integrated within the RF modules 320-322.

The network interface 310 also includes a PHY (Physical Layer) and MAC (Medium Access Control Layer) block 332 that includes modulators and demodulators, data conversion circuitry, and error correction circuitry. In some implementations, the functionality of the PHY and MAC block 332 is integrated within the RF modules 320-322. In some implementations, the network interface 310 also includes a microcontroller or processing unit, such as the network processor 334, that is capable of processing one or more types of received packets. Therefore, some packets are not transmitted from the network interface 330 to one of the components 340-360 such as at least the SoC 340. Interfaces 336 include circuitry for supporting one or more communication protocols used to transfer data and control signals with the components 340-360.

The metal traces on the printed circuit board used to transfer the signals 344-348, 352-354, and 362 have parameters similar to the parameters described earlier for the signals 126, 132, 142, 152, and 162 (of FIG. 1). These parameters affect whether the signals 344-348, 352-354, and 362 generate signal interference with another set of signals such as the input/output noise sensitive signals 324 of the network interface 310. The signal interference results from capacitive coupling (electric field dominant coupling), inductive coupling (magnetic field dominant coupling), and electromagnetic field coupling. To reduce or remove the signal interference in the computing system 300, the computing system 300 includes the circuitry 370 and 372 that are capable of adjusting the operating clock frequencies of the signals 344-348, 352-354, and 362. As described earlier, in various implementations, the circuitry 370 and 372 have the same functionality as the circuitry 170 and 172 (of FIG. 1).

In various implementations, the SoC 340 includes numerous functional blocks. Some of the functional blocks perform the functionality of an input/output interface controller such as receiving, storing, and transmitting request packets and response packets. Other functional blocks receive and direct interrupts such as an interrupt controller. Still other functional blocks generate clock signals, or transfer packets through a communication fabric. Yet still other functional blocks, which are referred to as clients, process requests and generate responses. As used herein, a “client” refers to an integrated circuit with data processing circuitry and local memory. Examples of clients are a host processor 342, such as a general-purpose central processing unit (CPU), a parallel data processing unit with a relatively wide single-instruction-multiple-data (SIMD) microarchitecture, a multimedia integrated circuit, a display engine or integrated circuit, one of a variety of types of an application specific integrated circuit (ASIC), a digital signal processor (DSP), a field programmable gate array (FPGA), one or more microcontrollers, and so forth.

In some implementations, the system memory 350 stores a base operating system (OS), one or more applications, and user data and result data (not shown). The system memory 350 includes any suitable memory devices such as one or more RAMBUS dynamic random access memories (DRAMs), synchronous DRAMs (SDRAMs), DRAM, static RAM, and so forth. The address space of the computing system 300 is divided among multiple memories corresponding to the multiple cores. In an implementation, the coherency point for an address is a system memory controller (not shown) for the system memory 350, which communicates with the system memory 350 storing bytes corresponding to the address. The system memory controller includes control circuitry for interfacing to memories of the system memory 350 and queues or other data storage areas for storing memory access requests and memory access responses.

The phase locked loop (PLL) 360 generates one or more system reference clock signals 362 to be used by multiple components in the computing system 300. The SoC 340 communicates with the network interface 310 through the input/output communication signals 348 and with other components (not shown) of the computing system 300 through the input/output communication signals 348. In addition, the SoC 340 communicates with a display controller through the display communication signals 348 and with the system memory 350 through the memory communication signals 354.

Interfaces of the SoC 340 support one or more of a variety of communication protocols such as one or more of the Peripheral Component Interconnect Express (PCIe) protocol, one of a variety of types of a Graphics Double Data Rate (GDDR) communication protocol, the DisplayPort protocol, the High-Definition Multimedia Interface (HDMI) protocol, one of a variety of types of the Universal Serial Bus (USB) protocol, the Compute Express Link (CXL) protocol, and so on. As described earlier, the circuitry 370 and 372 adjust the operating frequencies of the signals 344-348, 352-354, and 362 to reduce signal interference on the input/output noise sensitive signals 324 of the network interface 310. In various implementations, the circuitry 370 and 372 have the same functionality as the circuitry 170 and 172 (of FIG. 1).

In some implementations, the system memory 350 is one of a variety of types of DRAMS used as a video RAM (vRAM) for storing video frame data that is accessed by a parallel data processing unit (not shown) with a relatively wide single-instruction-multiple-data (SIMD) microarchitecture. In an implementation, the parallel data processing unit is a graphics processing unit (GPU), and this processing unit is included within the SoC 340 in some designs, or is located externally from the SoC 340 in other designs. In such implementations, the system memory 350 used as a vRAM is separate from another system memory of the computing system 300 that stores the base OS and one or more applications. The GPU is efficient for data parallel computing found within loops of applications, such as in applications for molecular dynamics simulations, finance computations, encryption/decryption computations, neural network training, and for manipulating, rendering, and displaying pixels of an image in a video frame. For example, the multiple, replicated lanes of execution provided by the compute units of the GPU are used for real-time data processing such as rendering multiple pixels, image blending, pixel shading, vertex shading, and geometry shading.

When the SoC 340 includes the GPU in addition to the host processor 342, the SoC 340 includes an interface with the system memory 350 being used as vRAM that supports one of a variety of types of communication protocols. Examples of the communication protocols are a Double Data Rate 4 Synchronous Dynamic Random-Access Memory (DDR4 SDRAM) communication protocol, a DDR 5 SDRAM (DDR5 SDRAM) communication protocol, a DDR 6 SDRAM (DDR6 SDRAM) communication protocol, a Graphics DDR 6 SDRAM (GDDR6 SDRAM) communication protocol, a Graphics DDR 7 SDRAM (GDDR7 SDRAM) communication protocol, and so forth. When the GPU is located externally from the SoC 340, the GPU includes an interface with the system memory 350 being used as vRAM that supports one of these examples of communication protocols.

When the SoC 340 includes the GPU in addition to the host processor 342, metal traces of the printed circuit board transport the memory communication signals 354 using operating clock frequencies of 3 gigahertz (GHz) and greater. Similarly, when the GPU is located externally from the SoC 340, metal traces of the printed circuit board transport the memory communication signals (not shown) using operating clock frequencies of 3 gigahertz (GHz) and greater. The combination of these high operating clock frequencies and parameters of the metal traces of the printed circuit board (metal widths, metal thicknesses, bus widths, trace lengths, particular metal compositions, signal routing shapes) used to transport the memory communication signals can cause the memory communication signals to generate signal interference with the input/output noise sensitive signals 324 of the network interface 310.

As described earlier, the circuitry 370 and 372 are used to reduce or remove the above signal interference with the input/output noise sensitive signals 324 by the circuitry 370 and 372 having the same functionality as the circuitry 170 and 172 (of FIG. 1). Therefore, in various implementations, the system memory 350 being used as vRAM includes the circuitry 372 that adjusts an operating clock frequency used by the system memory 350 based on information received from the circuitry 370 of the network interface 310. The circuitry 372 adjusts the operating clock frequency of the system memory 350 being used as vRAM to a frequency value that does not overlap with any of the one or more frequency ranges currently being used by the RF modules 320-322 of the network interface 110. The circuitry 372 also adjusts the operating clock frequency of the system memory 350 being used as vRAM to a frequency value that does not overlap with one or more harmonic frequencies of the one or more frequency ranges currently being used by the RF modules 320-322.

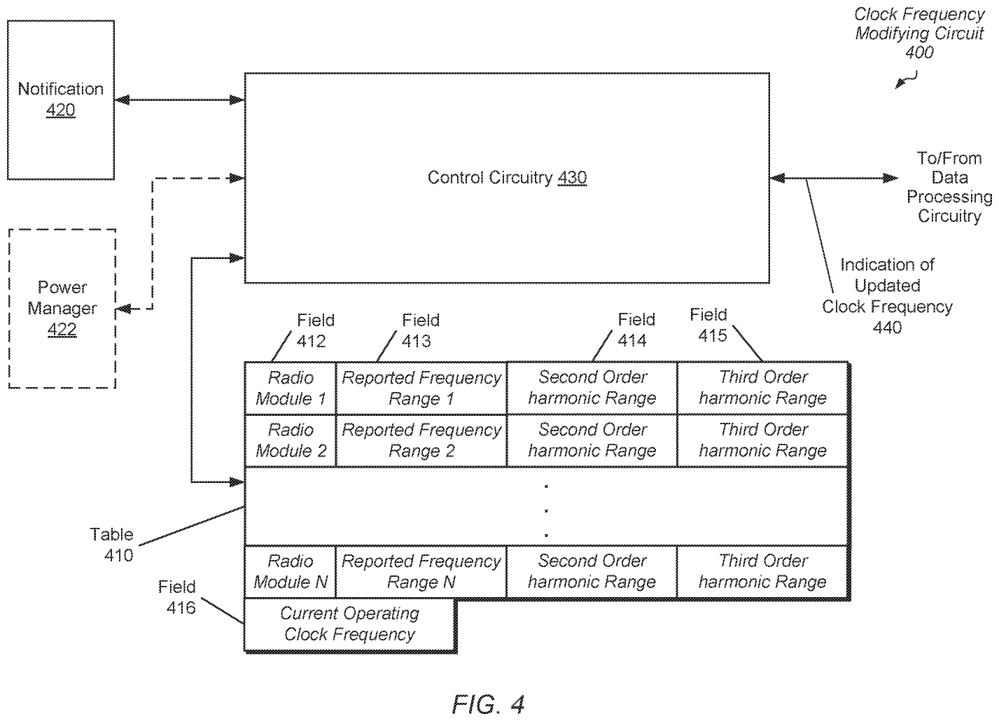

Referring to FIG. 4, a generalized block diagram is shown of a clock frequency modifying circuit 400. As shown, the clock frequency modifying circuit 400 (or circuit 400) includes the table 410 and the control circuitry 430. In various implementations, the circuit 400 is located within a component of a computing system on a printed circuit board. As described earlier regarding the description of the computing systems 100 and 300 (of FIGS. 1 and 3), examples of components are clients of a system on a chip (SoC), phased locked loop circuitry that provides system clock signals, one of a variety of types of off-chip system memory, a display engine, and so forth. In various implementations, the circuit 400 includes similar functionality as the circuitry 172 (of FIG. 1) and circuitry 372 (of FIG. 3).

The control circuitry 430 sends an indication 440 of an updated clock frequency to one or more functional blocks within the component. The control circuitry 430 does so in order to reduce or remove signal interference on the printed circuit board such as between signals generated by the corresponding component and input/output noise sensitive signals (wireless signals) of a network interface of the printed circuit board. In some implementations, the control circuitry 430 communicates with a power manager 422 that determines whether the corresponding component operates in an idle state or an active state. The power manager 422 is also capable of sending an indication of a power-performance state (P-state) to the control circuitry 430.

The table 410 includes multiple table entries (or entries), each storing information in multiple fields such as at least fields 412-416. The table 410 is a data storage area implemented with one of flip-flop circuits, a random-access memory (RAM), a content addressable memory (CAM), or other. Although particular information is shown as being stored in the fields 412-416 and in a particular contiguous order, in other implementations, a different order is used and a different number and type of information is stored. As shown, field 412 stores an identifier of a radio module of multiple radio modules of the network interface. The field 413 stores an indication of a reported frequency range currently used by the radio module identified in field 412. In various implementations, the frequency range corresponds to a particular channel of a radio frequency band of a communication protocol such as the IEEE 802.11 Wireless LAN protocol standard.

The field 414 stores a second order harmonic range based on the frequency range indicated by field 413. To determine a harmonic range, the control circuitry 430 multiples the lower and upper frequency limits of the frequency range by a positive, non-zero integer. For the harmonic range indicated by field 414, the positive, non-zero integer is two. Similarly, the field 415 stores a third order harmonic range based on the frequency range indicated by field 413. For the harmonic range indicated by field 415, the positive, non-zero integer used by the control circuitry 430 is three. The control circuitry 430 is able to determine other harmonic frequencies based on the frequency range indicated by field 413 such as harmonic frequencies based on integers of four, five, and so on. Therefore, the table 410 includes other fields to store these other harmonic frequencies.

In an implementation, the control circuitry 430 also determines harmonic frequencies by multiplying the lower and upper frequency limits of the frequency range indicated by field 413 by a positive fraction less than one. In an implementation, the control circuitry multiples the lower and upper frequency limits of the frequency range by one half (or ½). Other fractions are possible and contemplated. The field 416 stores an indication of the current operating clock frequency used by the component that includes the circuit 400.

The control circuitry 430 updates the values stored in the table 410 based on the received notification 420. The network interface includes radio frequency range reporting circuitry that sends, to the circuitry 400, an indication of a frequency range currently being used by a radio module of the network interface. The notification 420 can include the indication specifying the frequency range, or the notification 420 can provide an indication of a memory location that stores the indication specifying the frequency range. In an implementation, the network interface and the circuit 400 of a component on the printed circuit board use the Advanced Configuration and Power Interface (ACPI) specification for communication. For example, independent of the operating system, the driver of the network interface communicates with the driver of the component to convey the indication specifying the frequency range. In an implementation, the network interface sends a broadcast of a change in a frequency range of a radio module when a change occurs. The components of the computing system do not poll the network interface.

In one implementation, an ACPI namespace is defined with a name that provides a device specific ACPI method (DSM) with an associated unique identifier. This is used to provide an API to record the frequency band(s) currently used by the radio frequency (e.g., WiFi) infrastructure. The wireless software stack (e.g., Wifi6/6e/7, Bluetooth, ZigBee, 5G, etc.) calls the DSM method to provide an array of frequency bands that are expected to be in use. Subsequent calls to the DSM method will provide updated frequency values, and it is expected that the Wifi stack is calling the method each time it changes channels. In various implementations, the platform firmware may initiate a platform event generating an interrupt to the appropriate ACPI device objects that represent the potential interference causing mechanisms and ultimately gets reported to the component driver as a “system event.” This may, for example, be similar to a device hot plug or thermal event. The appropriate devices receive the notification and evaluate if any of their clocks or their harmonics (e.g., 2×, 3×, . . . ) would fall into the affected frequency range and if so, these devices are expected to change their clocks to a value that is outside of the interference range. The retrieval of the information may be either directly through a pre-negotiated physical memory buffer provided by the platform or through another DSM method where the exclusion frequency bands can be explicitly queried by a client. Any component that may create frequency harmonics and radio frequency interference in some of the affected frequency ranges can use the mechanism. Such components can be a discrete GPU memory, display circuitry, CPU clocks, system memory controller, or otherwise. As an example, in various implementations the following functions are provided by the DSM method, using a structure such as the following in memory.

```
struct exclusion_bands {
  uint32_t number_of_entries;
  uint32_t add_remove
  struct {
    uint64_t start_freq; // in Hz
    uint64_t end_freq; // in Hz
  } band[ ];
};
```

| DSM | | |
|---|---|---|
| Method | | |
| ID | Function | Comments |
| 0 | discover # of | used to identify the number of active methods for this |
| | functions | DSM |
| | available | |
| 1 | record the used | Used by a radio based device driver to record what |
| | wifi band(s) | frequency bands are used. |
| | parameters | This information is stored in firmware provided physical |
| | (BUFFER): | system memory location where the data can be retrieved |
| | reference to | from either directly (if firmware is responsible for |
| | exclusion_bands | frequency changes) or via a different DSM function ID |
| | data array | from the OS driver level. |
| | | The add_remove entry allows the wireless driver to add |
| | | or remove entries to the overall list of blocked RF |
| | | frequency bands. |
| | | 0: add the array information to the list |
| | | 1: remove the array band(s) from the list |
| | | If a driver removes a band that is not recorded already, |
| | | the method succeeds, but does not do anything. |
| 2 | retrieve the used | Used by any OS driver or system component that may |
| | wifi band(s) | produce sufficiently powerful clock frequencies or |
| | array | harmonics and needs to set its clocks in a way to not |
| | | interfere with the wireless frequency bands. |

As may be appreciated by those skilled in the art, structures than the one presented above may be used to implement the indicated functionality. Additionally, as an alternate implementation option to the firmware maintained table in system memory, the DSM method may directly write to a memory location that then allows the appropriate component to read the information directly.

The control circuitry 430 determines whether an operating clock frequency of the given component (with an indication stored in field 416) overlaps any of the operating frequency ranges and associated harmonic frequencies (with indications stored in fields 412-415). If there is an overlap, then the control circuitry 430 changes the operating clock frequency to a frequency that does not overlap any of the operating frequency ranges and associated harmonic frequencies. The control circuitry 430 performs this determination when any updates occur such as when new information is received by notification 420 or the power manager 422. In some implementations, the control circuitry 430 maintains, in either the table 410 or programmable configuration registers, thresholds for multiple frequency ranges. The control circuitry 430 ensures an absolute value of a difference between an adjusted operating clock frequency and a lower or upper frequency limit of a particular frequency range is greater than a corresponding threshold.

In various implementations, the given component using the circuit 400 is one of a variety of types of DRAMs used as a video RAM (vRAM) for storing video frame data that is accessed by a GPU. As described earlier, examples of the types of DRAMs are DRAMs that support communication protocols such as the DDR4 SDRAM communication protocol, the DDR5 SDRAM communication protocol, the DDR6 SDRAM communication protocol, the GDDR6 SDRAM communication protocol, the GDDR7 SDRAM communication protocol, and so forth. The vRAM uses the circuit 400 to adjust the operating clock frequency of the vRAM to a frequency value that does not overlap with any of the frequency ranges indicated by the fields 413-415 of the table 410. Therefore, the metal traces on the printed circuit board that transport control signals and data signals between the GPU and the vRAM do not generate signal interference with the signals being wirelessly transported by the multiple radio modules of the network interface that have corresponding information stored in the table 410.

For the below descriptions of methods 500-700 of FIGS. 5-7, in various implementations, a computing system is a printed circuit board of a mobile computing device that includes multiple components for processing tasks. Examples of the components, which are subsystems on the printed circuit board, are a system on a chip (SoC), phased locked loop circuitry that provides system clock signals, one of a variety of types of off-chip system memory, a display engine, and so forth. The computing system includes a network interface. In some implementations, the circuitry of the network interface is included in a network interface card in a slot on the motherboard of the remote computing device. Therefore, relative to the location of a processing node or component, the location of the network interface is considered local, and as used herein, the term “network interface” can also refer to “local area network circuitry.” In other implementations, the circuitry of the network interface (or local area network circuitry) is included in a local area network on motherboard (LOM) with circuitry in a semiconductor chip directly embedded on the motherboard. In an implementation, the network interface is a wireless local area network (WLAN) that supports a wireless connection with the network.

Referring to FIG. 5, a generalized block diagram is shown of a method 500 for increasing reliable wireless signal transfer performed by a computing device. A given radio module of multiple modules of a network interface transfers data with an access point using a first operating frequency range (block 502). If the given radio module does not determine that the access point has changed data transfer to using a second operating frequency range (“no” branch of the conditional block 504), then control flow of method 500 returns to block 502 where the given radio module transfers data with an access point using the first operating frequency range.

If the given radio module determines that the access point has changed data transfer to using a second operating frequency range different from the first operating frequency range (“yes” branch of the conditional block 504), then the given radio module transfers data with the access point using the second operating frequency range (block 506). The network interface sends, to one or more components of multiple components of a computing system, an indication specifying the second operating frequency range to (block 508). For example, the network interface broadcasts messages to the one or more components using the ACPI specification or other specification for communication.

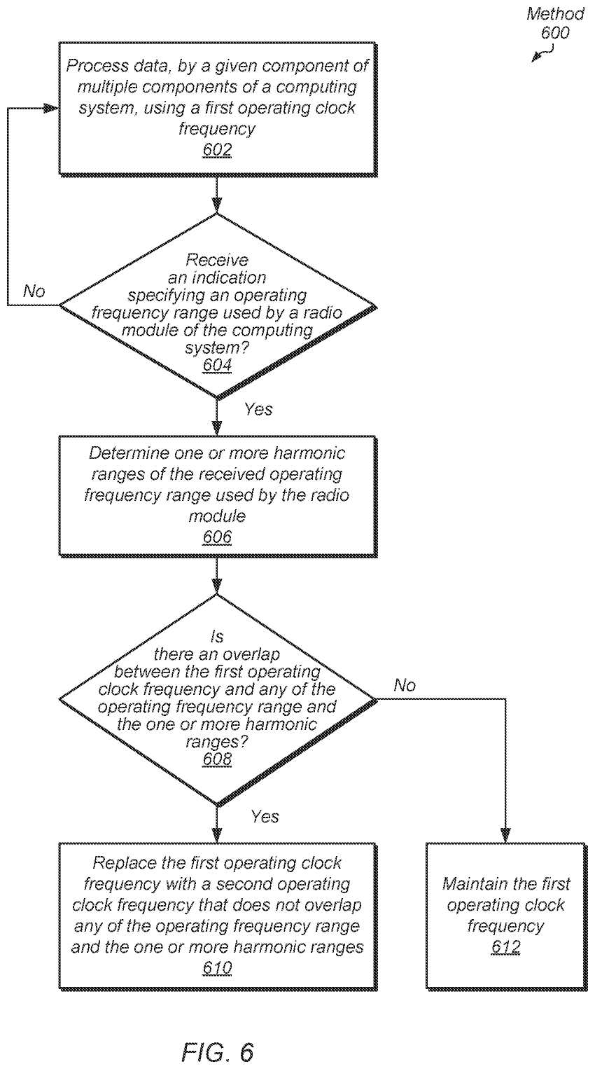

Turning now to FIG. 6, a generalized block diagram is shown of a method 600 for increasing reliable wireless signal transfer performed by a computing device. A given component of multiple components of a computing system processes data by using a first operating clock frequency (block 602). If the given component does not receive an indication specifying an operating frequency range used by a radio module of the computing system (“no” branch of the conditional block 604), then control flow of method 600 returns to block 602. Otherwise, if the given component receives an indication specifying an operating frequency range used by a radio module of the computing system (“yes” branch of the conditional block 604), then the given component determines one or more harmonic frequencies of the received operating frequency range used by the radio module (block 606).

If the given component determines that there is an overlap between the first operating clock frequency and any of the operating frequency range and the one or more harmonic frequencies (“yes” branch of the conditional block 608), then the given component replaces the first operating clock frequency with a second operating clock frequency that does not overlap any of the operating frequency range and the one or more harmonic frequencies (block 610). In some implementations, the given component is one of a variety of types of DRAMs being used as a video RAM (vRAM) for storing video frame data that is accessed by a GPU. As described earlier, examples of the types of DRAMs are DRAMs that support communication protocols such as the DDR4 SDRAM communication protocol, the DDR5 SDRAM communication protocol, the DDR6 SDRAM communication protocol, the GDDR6 SDRAM communication protocol, the GDDR7 SDRAM communication protocol, and so forth. The vRAM adjusts the operating clock frequency of the vRAM to a frequency value that does not overlap does not overlap any of the operating frequency range and the one or more harmonic frequencies. Therefore, the metal traces on the printed circuit board that transport control signals and data signals between the GPU and the vRAM do not generate signal interference with the signals being wirelessly transported by the radio module of the network interface.

If the given component determines that there is no overlap between the first operating clock frequency and any of the operating frequency range and the one or more harmonic frequencies (“no” branch of the conditional block 608), then the given component maintains the first operating clock frequency (block 612). In some implementations, the given component maintains thresholds for multiple frequency ranges. The given component ensures an absolute value of a difference between an adjusted operating clock frequency and a lower or upper frequency limit of a particular frequency range is greater than a corresponding threshold.

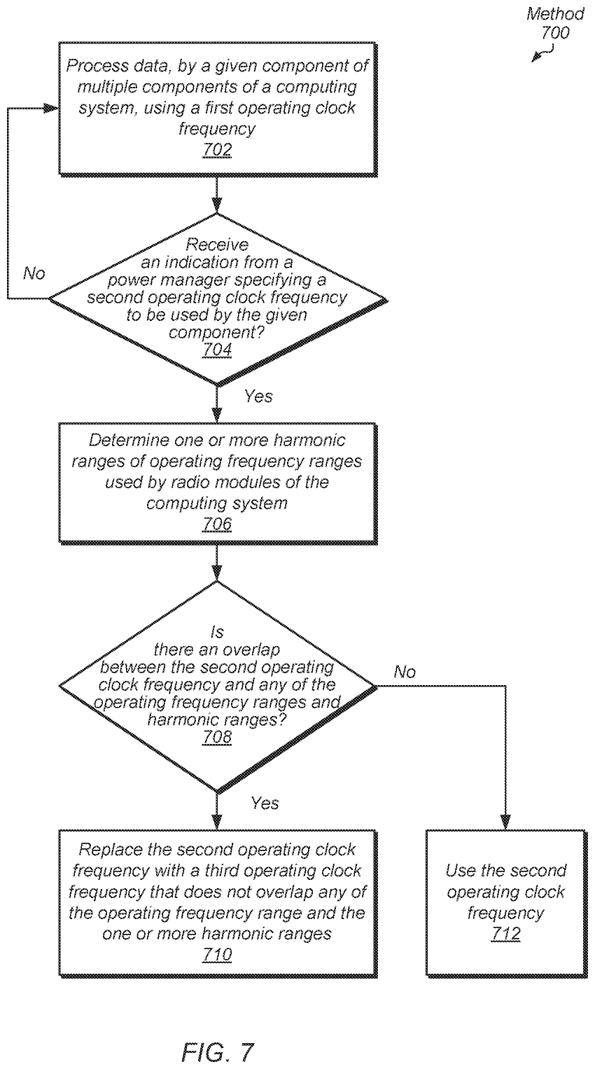

Referring to FIG. 7, a generalized block diagram is shown of a method 700 for increasing reliable wireless signal transfer performed by a computing device. A given component of multiple components of a computing system processes data using a first operating clock frequency (block 702). If the given component does not receive an indication from a power manager specifying a second operating clock frequency to be used by the given component (“no” branch of the conditional block 909), then control flow of method 700 returns to block 702. Otherwise, if the given component receives an indication from the power manager specifying a second operating clock frequency different from the first operating clock frequency to be used by the given component (“yes” branch of the conditional block 704), then the given component determines one or more harmonic frequencies of operating frequency ranges used by radio modules of the computing system (block 706).

If the given component determines that there is an overlap between the second operating clock frequency and any of the operating frequency ranges and harmonic frequencies (“yes” branch of the conditional block 708), then the given component replaces the second operating clock frequency with a third operating clock frequency that does not overlap any of the operating frequency ranges of the radio modules and the one or more corresponding harmonic frequencies (block 710). Otherwise, if the given component determines that there is no overlap between the second operating clock frequency and any of the operating frequency ranges of the radio modules and the one or more corresponding harmonic frequencies (“no” branch of the conditional block 708), then the given component uses the second operating clock frequency (block 712). In some implementations, the given component maintains thresholds for multiple frequency ranges. The given component ensures an absolute value of a difference between an adjusted operating clock frequency and a lower or upper frequency limit of a particular frequency range is greater than a corresponding threshold.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
receive an indication specifying an operating frequency range used by circuitry of a given radio module of a computing system; and
replace a first clock frequency used by a component of the computing system with a second clock frequency, in response to first clock frequency overlapping with the operating frequency range used by given radio module circuitry of the computing system.

2. The apparatus as recited in claim 1, wherein the component is a memory device.

3. The apparatus as recited in claim 2, wherein the circuitry is further configured to determine one or more harmonic frequencies of the operating frequency range used by the circuitry of the given radio module.

4. The apparatus as recited in claim 3, wherein the circuitry is further configured to replace the first clock frequency with the second clock frequency, in response to the second clock frequency overlapping any of the one or more harmonic frequencies.

5. The apparatus as recited in claim 1, wherein the indication further specifies at least one harmonic range of the operating frequency range.

6. The apparatus as recited in claim 1, wherein the component is an access point.

7. The apparatus as recited in claim 1, wherein the circuitry is further configured to:
determine one or more harmonic frequencies of operating frequency ranges used by a plurality of radio modules, in response to an indication from a power manager specifying a third clock frequency; and
use the third clock frequency, in response to the third clock frequency not overlapping any of the one or more harmonic frequencies of operating frequency ranges used by the plurality of radio modules.

8. A method, comprising:
receiving, by a given component of a plurality of components, an indication specifying an operating frequency range used by circuitry of a given radio module of a computing system; and
replacing, by the given component, a first clock frequency used by circuitry of the given component with a second clock frequency, in response to the first clock frequency overlapping with the operating frequency range used by given radio module circuitry of the computing system.

9. The method as recited in claim 8, wherein the given component is a memory device.

10. The method as recited in claim 8, further comprising determining, one or more harmonic frequencies of the operating frequency range used by the circuitry of the given radio module of the computing system.

11. The method as recited in claim 10, further comprising replacing, by the given component, the first clock frequency with the second clock frequency, in response to the second clock frequency overlapping any of the one or more harmonic frequencies.

12. The method as recited in claim 8, wherein the indication further specifies at least one harmonic range of the operating frequency range.

13. The method as recited in claim 8, wherein the given component is an access point.

14. The method as recited in claim 8, further comprising:
determining, by the given component, one or more harmonic frequencies of operating frequency ranges used by the circuitry of the given radio module, in response to an indication from a power manager specifying a third clock frequency; and
using, by the given component, the third clock frequency, in response to the third clock frequency not overlapping any of the one or more harmonic frequencies.

15. A computing system comprising:
network interface circuitry comprising radio frequency circuitry; and
a processing node comprising a plurality of components; and
wherein circuitry of a given component of the plurality of components is configured to:
receive an indication specifying an operating frequency range used by the radio frequency circuitry; and
replace a first clock frequency used by the given component of the computing system with a second clock frequency, in response to first clock frequency overlapping with the operating frequency range used by radio frequency circuitry.

16. The computing system as recited in claim 15, wherein the given component is a memory device.

17. The computing system as recited in claim 16, wherein the first clock frequency is a clock frequency of a clock signal conveyed to the memory device.

18. The computing system as recited in claim 17, wherein the indication further identifies one or more harmonic frequencies of the operating frequency range used by the radio frequency circuitry.

19. The computing system as recited in claim 18, wherein the given component is further configured to replace the first clock frequency with the second clock frequency, in response to the first clock frequency overlapping at least one of the one or more harmonic frequencies.

20. The computing system as recited in claim 15, wherein the given component is an access point.
